(19) United States
(12) Patent Application Publication
(10) Pub. No.: US 2025/0086696 A1
(43) Pub. Date: Mar. 13, 2025

(54) System and Method for Real-Time Media Capture, Analysis, and Repository Management

(71) Applicant: Joshua Emmanuel Short, Davenport, FL (US)

(72) Inventor: Joshua Emmanuel Short, Davenport, FL (US)

(21) Appl. No.: 18/792,718

(22) Filed: Aug. 2, 2024

Related U.S. Application Data
(60) Provisional application No. 63/538,070, filed on Sep. 13, 2023.

(51) Int. Cl. G06Q 30/0645; G06Q 40/08; H04N 21/2743; H04N 23/63

(52) U.S. Cl. CPC G06Q 30/0645; G06Q 40/08; H04N 21/2743; H04N 23/631

(57) ABSTRACT

A system and related methods for capturing, analyzing, and managing media, especially incident-related media, comprising a mobile device equipped with a camera, microphone, touch screen, processor, and non-transitory memory with executable instructions. The mobile device runs a mobile application configured to initiate live recording of media, provide audible and visual prompts for capturing specific media elements, generate a unique identifier for the recorded media, prevent alteration or deletion of the media, and upload the media along with its identifier to a server when a network connection is available. The server receives and stores the uploaded media, processes it using artificial intelligence to extract and categorize data, and maintains a searchable repository of the stored media, indexed by unique identifiers.

### FIELD OF INVENTION

The present invention relates generally to systems and methods for capturing, analyzing, and managing media, especially media related to incidents of property damage or personal injury. Specifically, it involves a mobile application and web-based platform for real-time recording, secure storage, and searchable access to uploaded data.

### BACKGROUND

Current systems for capturing and managing incident data, particularly in the context of property damage or personal injury, exhibit several limitations that necessitate improvement. Traditional methods of documenting incidents often rely on manual recording and post-event recollections, which can be prone to errors, omissions, and subjective alterations. These conventional approaches fail to provide real-time, accurate, and tamper-proof records, leading to disputes and challenges in verifying the authenticity of the captured data.

Furthermore, existing platforms typically lack comprehensive and systematic guidance for users on what specific information and media should be captured during an incident. This results in incomplete or inconsistent documentation, which can hinder subsequent investigations or claims processing. Additionally, the storage and management of incident data are often decentralized and fragmented, making it difficult for stakeholders to access and retrieve relevant information efficiently.

The ability to monetize captured incident data remains underdeveloped, with limited mechanisms for compensating individuals or entities who contribute valuable media. Current systems do not adequately incentivize thorough and accurate data collection, nor do they offer robust methods for third parties to search and procure incident-related media. This lack of a structured marketplace for incident data reduces the potential benefits for both data contributors and users seeking specific incident information.

Moreover, the integrity and security of incident media are critical concerns. Many existing systems do not implement adequate measures to prevent the alteration or deletion of media once captured, raising questions about the reliability and credibility of the evidence. There is also a need for advanced features, such as artificial intelligence (AI) for media analysis and categorization, to enhance the utility and accessibility of incident data.

In summary, the current landscape of incident data capture and management is marked by significant drawbacks, including the absence of real-time guidance, fragmented data storage, inadequate monetization options, and insufficient security measures. These factors collectively impede the effective documentation, verification, and utilization of incident-related media, underscoring the need for a more sophisticated and integrated solution.

It is within this context that the present invention is provided.

### SUMMARY

The present invention is a system for capturing, analyzing, and managing media, and especially incident-related media. The system comprises a mobile device with a camera, microphone, touch screen, processor, and non-transitory memory. A mobile application on the device initiates live recording, provides prompts for capturing media, generates a unique identifier, prevents alteration or deletion of the media, and uploads the media to a server when connected to a network. The server receives and stores the media, processes it using artificial intelligence to extract and categorize data, and maintains a searchable repository of the stored media.

In some embodiments, the mobile application detects the geolocation of the device and associates this data with the recorded media. This feature enhances the accuracy and relevance of the media by providing precise location information.

In some embodiments, the mobile application detects the orientation of the device and associates this data with the recorded media. This feature ensures that the spatial context of the incident is accurately captured.

In some embodiments, the server generates thumbnails of the recorded media for display in search results. This feature facilitates quick visual identification and retrieval of relevant media.

In some embodiments, the artificial intelligence on the server analyzes the media for specific attributes, such as severity, terrain, light exposure, logos, license plates, vehicle identification numbers, and spoken words. This feature allows for detailed categorization and filtering of the media.

In some embodiments, the mobile application generates and embeds a digital watermark on the recorded media, identifying the user. This feature enhances the security and traceability of the media.

In some embodiments, the server provides third-party access to the repository, enabling search and retrieval of media by unique identifiers like vehicle identification numbers or addresses. This feature broadens the utility of the system by facilitating external searches.

In some embodiments, the mobile application continues to record and store media locally when a network connection is unavailable, and uploads the media once the connection is reestablished. This feature ensures uninterrupted media capture and eventual upload.

In some embodiments, the mobile application receives and uploads non-live-captured media from external devices, such as dash cameras, body cameras, and security cameras. This feature expands the range of media sources that can be integrated into the system.

In some embodiments, the server distributes payments to users based on third-party downloads of the uploaded media. This feature provides a financial incentive for users to capture and upload high-quality media.

In some embodiments, the mobile application measures distances and dimensions within the recorded media using on-screen tools and prompts. This feature aids in accurate documentation of spatial details in the incident scene.

In some embodiments, the server associates additional information provided by the user with the recorded media, such as written or audio descriptions, insurance information, police report numbers, and names of involved parties. This feature enriches the media with contextual data.

In some embodiments, the mobile application allows users to capture and record current conditions of property for documentation purposes, including pre-rental or pre-sale inspections. This feature supports comprehensive property condition documentation.

In some embodiments, the mobile application tags and categorizes the recorded media based on user input and predefined criteria. This feature improves the organization and retrieval of media.

In some embodiments, the server integrates with external databases to retrieve and correlate additional information related to the incident, such as weather conditions and traffic reports at the time of the incident. This feature enhances the contextual understanding of the media.

In some embodiments, the server generates detailed reports based on the processed media, including chronological timelines and incident summaries. This feature provides structured and comprehensive documentation of incidents.

In some embodiments, The system of claim 1, wherein a mobile application integrated within and communicates with a mobile, battery-reliant piece of property, configured such that when the mobile property or mobile device senses an accident, it will automatically start capturing and storing data utilizing the available media-capturing components of the mobile device and application until the user stops it or the battery dies, and extracts analytics from the users' mobile properties CPU and or Event Data Recorder, storing the crash data within the upload to the servers.

### BRIEF DESCRIPTION OF THE DRAWINGS

Various embodiments of the invention are disclosed in the following detailed description and accompanying drawings.

FIG. 1 illustrates an example mobile device data collection system including components for media capture, processing, and storage.

FIG. 2 illustrates an example method flowchart showing the sequence of operations for capturing and uploading incident-related media using the system.

FIG. 3A illustrates an example user interface with a realistic view of the live scene, providing audible and visual cues during media capture.

FIG. 3B illustrates an example user interface prompting the user to start live recording and capture photos while recording.

FIG. 3C illustrates an example user interface confirming the successful capture and upload of incident media, allowing the user to link the incident to appropriate parties.

FIG. 3D illustrates an example user interface for additional data collection, providing options for manual additions of identifying information and written statements.

FIG. 3E illustrates an example user interface with an on-screen measuring tool for capturing precise spatial information within the recorded media.

FIG. 3F illustrates an example user interface for additional media collection specific to recording various statements and additional footage of the scene.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

### DEFINITIONS

The terminology used herein is for the purpose of describing particular embodiments only and is not intended to be limiting of the invention.

As used herein, the term “and/or” includes any combinations of one or more of the associated listed items.

As used herein, the singular forms “a,” “an,” and “the” are intended to include the plural forms as well as the singular forms, unless the context clearly indicates otherwise.

It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

As used herein, the term “mobile device” refers to any portable computing device that includes, but is not limited to, smartphones, tablets, personal digital assistants (PDAs), and wearable devices. The mobile device must be equipped with a camera, microphone, touch screen, processor, and non-transitory memory capable of executing instructions from a mobile application.

The term “media” encompasses any form of digital data that can be captured by the mobile device's camera and microphone, including but not limited to, video, audio, images, and combinations thereof. Media may also include metadata such as time stamps, geolocation data, and device orientation data.

The term “unique identifier” refers to a code or number generated by the mobile application that uniquely associates the recorded media with a specific incident. This identifier can be in the form of a numeric code, alphanumeric code, or any other unique string that ensures no two incidents have the same identifier.

The term “artificial intelligence” (AI) refers to any machine learning or computational algorithm that processes the recorded media to extract and categorize data. Example AI methods and models include, but are not limited to, convolutional neural networks (CNNs) for image recognition, recurrent neural networks (RNNs) for speech recognition, and natural language processing (NLP) algorithms for text analysis.

The phrase “audible and visual prompts” refers to instructions provided by the mobile application via sound (e.g., spoken instructions, beeps) and visual cues (e.g., text, icons) on the touch screen. These prompts guide the user in capturing specific elements of the incident, ensuring comprehensive and consistent documentation.

The term “communication protocol” refers to the set of rules and conventions for data exchange between the mobile device and the server. Example communication protocols include, but are not limited to, Hypertext Transfer Protocol Secure (HTTPS), WebSocket, and File Transfer Protocol (FTP).

The term “non-transitory memory” refers to any memory that does not lose its data when power is removed. This includes, but is not limited to, flash memory, solid-state drives (SSDs), hard disk drives (HDDs), and read-only memory (ROM).

### DESCRIPTION OF DRAWINGS

The present invention provides a comprehensive system and method for capturing, analyzing, and managing media related to various contexts, including but not limited to incidents and conditions of property. This system addresses significant shortcomings in traditional methods by offering real-time, accurate, and tamper-proof recording capabilities, ensuring that all necessary media elements are documented correctly.

The mobile application enhances data capture through real-time audible and visual prompts, guiding users to ensure thorough documentation. This feature mitigates the risk of incomplete or inconsistent media capture, which is common with conventional methods. By generating a unique identifier for each recorded media and preventing any alteration or deletion, the system guarantees the integrity and authenticity of the captured data.

The invention's integration with a server that processes media using artificial intelligence significantly enhances the categorization and search-ability of the data. This capability allows for efficient indexing and retrieval of media by unique identifiers such as vehicle identification numbers (VINs), addresses, or other relevant identifiers. The AI processing can analyze media for attributes like severity, terrain, light exposure, visible logos, license plates, vehicle identification numbers, and spoken words or phrases. This makes the system a valuable resource for various stakeholders, including law enforcement, insurance companies, businesses, and individuals.

One of the key advantages of this system is its ability to provide financial incentives for users who capture and upload high-quality media. By allowing third-party access to the repository and facilitating payments for media downloads, the system encourages thorough and accurate data collection. This feature not only enhances the repository's robustness but also ensures that users are compensated for their contributions.

The system is versatile, extending beyond incident reporting to serve as a tool for documenting the current state of property or cataloguing any media that requires systematic organization and search-ability. This functionality is particularly useful for transactions such as rentals or sales, where accurate documentation of property conditions can prevent disputes and ensure transparency.

Moreover, the system's ability to integrate media from various sources, including dash cameras, body cameras, security cameras, and even personal recordings, ensures comprehensive coverage of any media context. The mobile application's capability to continue recording and storing media locally when a network connection is unavailable guarantees uninterrupted data capture, further enhancing the system's reliability.

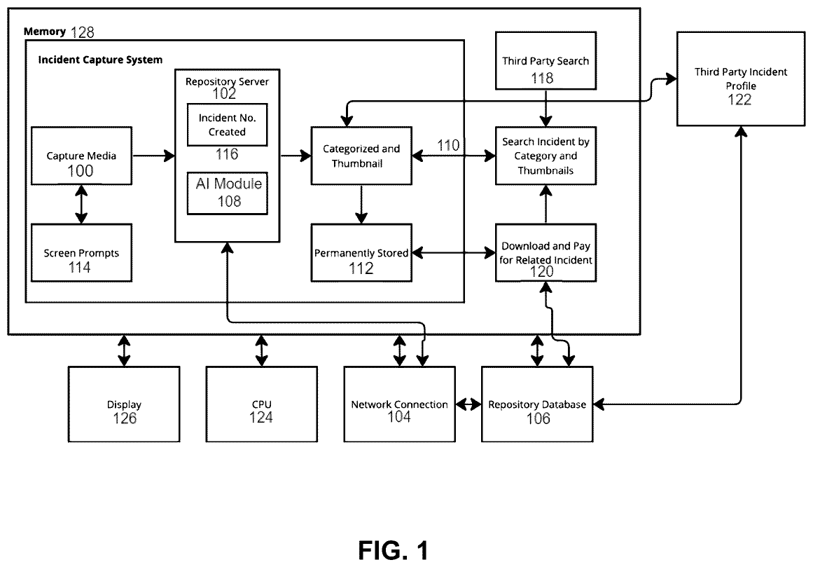

Referring to FIG. 1, an example system for capturing, analyzing, and managing media is illustrated. The mobile device includes a camera, microphone, touch screen, processor, and non-transitory memory for media capture 100. The mobile device operates in conjunction with a mobile application designed to initiate live recording, provide audible and visual prompts, generate a unique incident identifier, and prevent media alteration or deletion. The captured media is uploaded to the repository server 102 when a network connection is available.

The repository server 102 is connected to a network connection 104 and a repository database 106, where the uploaded media is stored. The AI module 108 analyzes the media, extracting and categorizing data based on attributes such as severity, terrain, light exposure, visible logos, license plates, vehicle identification numbers, and spoken words. The media, now categorized and thumbnailed for searching 110, is stored permanently 112 in the repository database 106.

The system includes a user interface that provides screen prompts 114 to guide users during media capture, ensuring comprehensive documentation. The media is assigned an incident number 116 upon upload, serving as a unique identifier for each recorded event.

Third-party search 118 is enabled through the repository database 106, allowing external users to search incidents by category and thumbnails. Users can download and pay for related incidents 120, with payments distributed to the original media uploaders. The third-party incident profile 122 links specific incidents to relevant third parties, such as insurance companies, law enforcement agencies, or other stakeholders.

The CPU 124 manages the overall operation of the mobile device, coordinating with the display 126, network connection 104, and repository database 106. The system ensures that all captured media is securely stored and readily accessible, maintaining the integrity and authenticity of the data. The network connection 104 can utilize various communication protocols such as HTTPS or WebSocket to ensure secure and efficient data transmission.

The incident capture system operates within the mobile device's memory 128, seamlessly integrating with its hardware and software components. This integration allows for real-time media capture, local storage, and subsequent upload to the repository server 102, even in scenarios where network connectivity is temporarily unavailable.

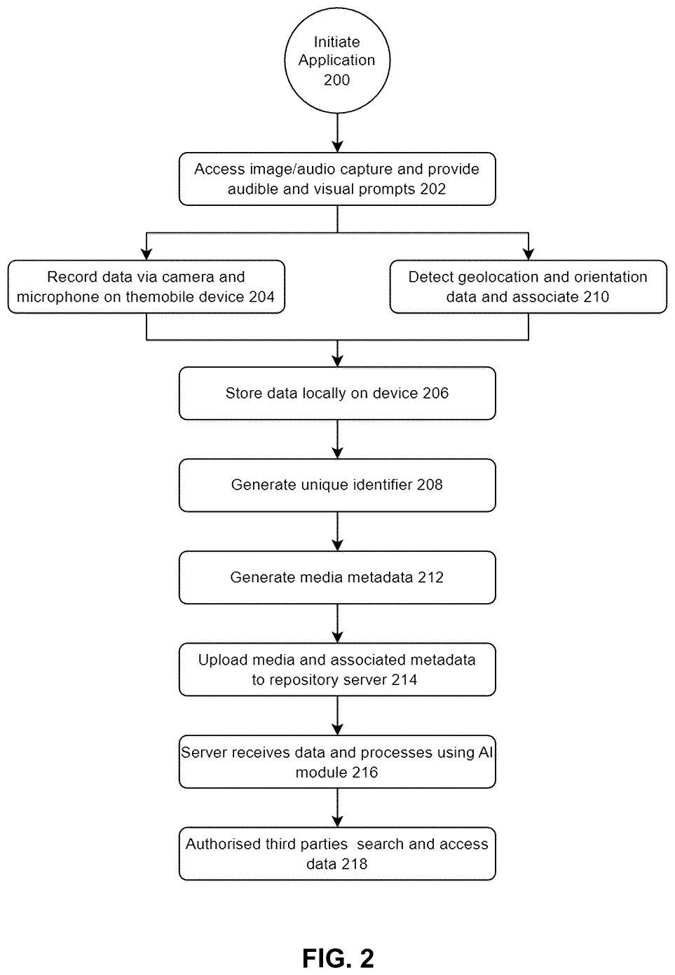

Referring to FIG. 2, a method flowchart illustrating the sequence of operations carried out by the system when a user has been in a car incident and uses their mobile phone to capture and upload images and other data to report the incident is shown. The process begins with the initiation of the mobile application 200 on the mobile device.

Upon activation, the application accesses image/audio capture and provides audible and visual prompts 202 to guide the user in capturing specific media elements related to the car incident. These prompts ensure that all necessary data, such as images of the damage, license plates, and the surrounding scene, are accurately documented.

Once the user begins capturing media, the application records the images and other data via the camera and microphone on the mobile device 204. The media is temporarily stored locally on the device 206, ensuring that no data is lost even if network connectivity is unavailable at the time. The application generates a unique incident identifier 208, associating it with the recorded media to maintain a distinct and tamper-proof record of the incident.

The mobile device may also detect geolocation and orientation data 210, associating this information with the captured media to provide precise context for the incident. The data, including geolocation and orientation, is then included in the media metadata 212, enhancing the utility and search-ability of the stored information.

When a network connection becomes available, the application uploads the recorded media and associated metadata 214 to the repository server 102. The server receives and stores the uploaded media in the repository database 106. The AI module 108 processes the media 216, analyzing it for specific attributes such as severity, terrain, light exposure, visible logos, license plates, and vehicle identification numbers. This processing step categorizes the media and generates thumbnails, facilitating efficient search and retrieval.

The media and its metadata are permanently stored in the repository database 106. Third parties, such as insurance companies or law enforcement agencies, can then access the repository 224, searching for incidents by category and thumbnails. The system allows these third parties to download and pay for the relevant media 226, with payments credited to the original uploader.

Throughout this process, the system ensures the integrity and authenticity of the captured media. The unique incident identifier, coupled with the prohibition of media alteration or deletion, guarantees that the data remains reliable and trustworthy. The mobile application's prompts and the AI-driven categorization further enhance the comprehensiveness and utility of the captured data.

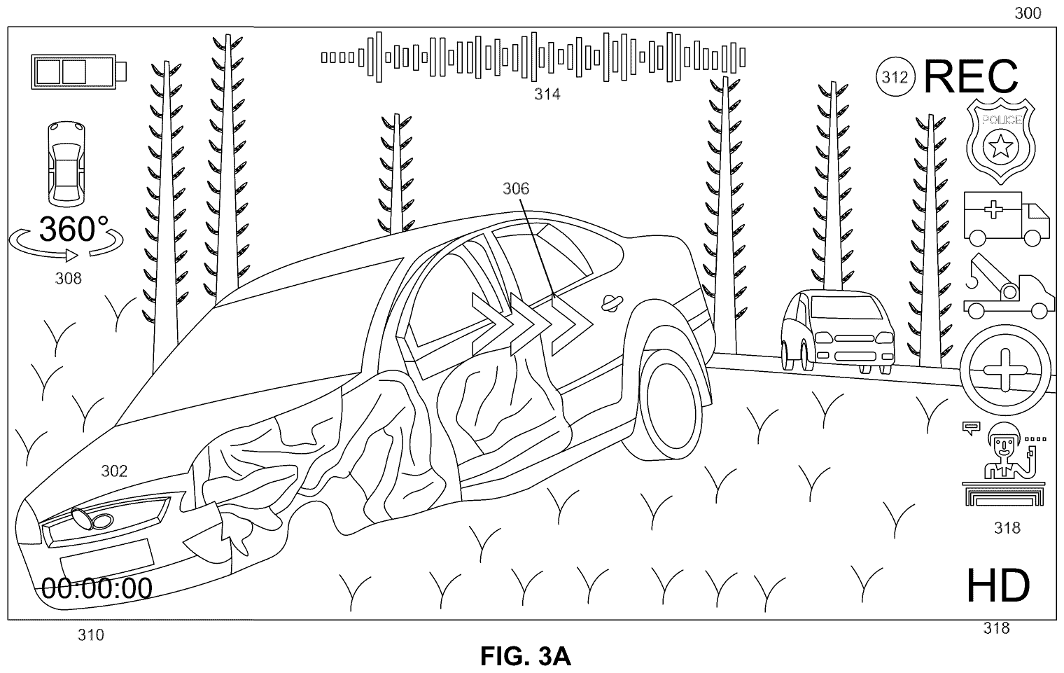

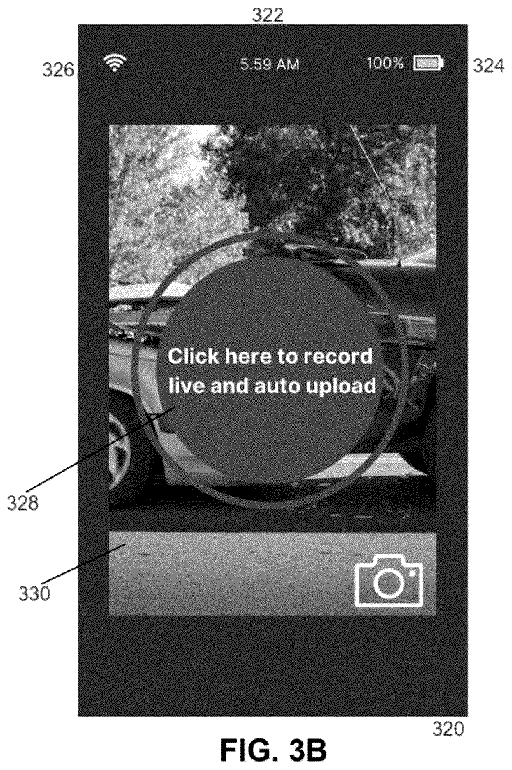

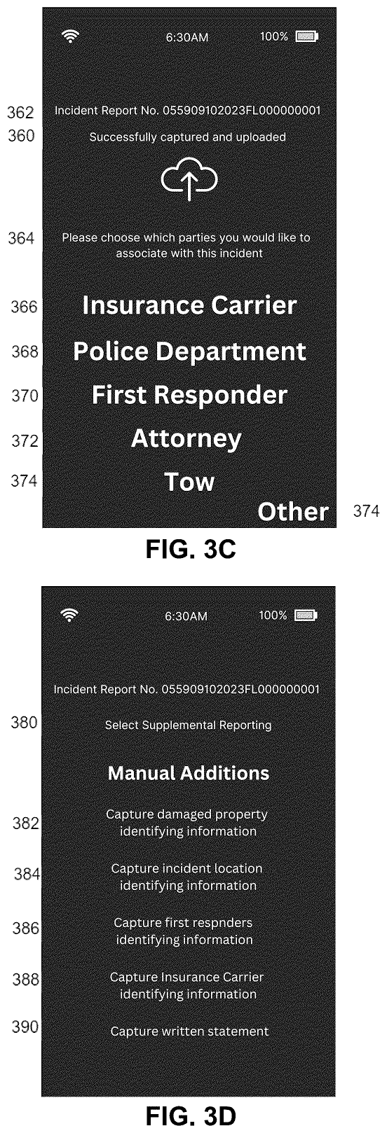

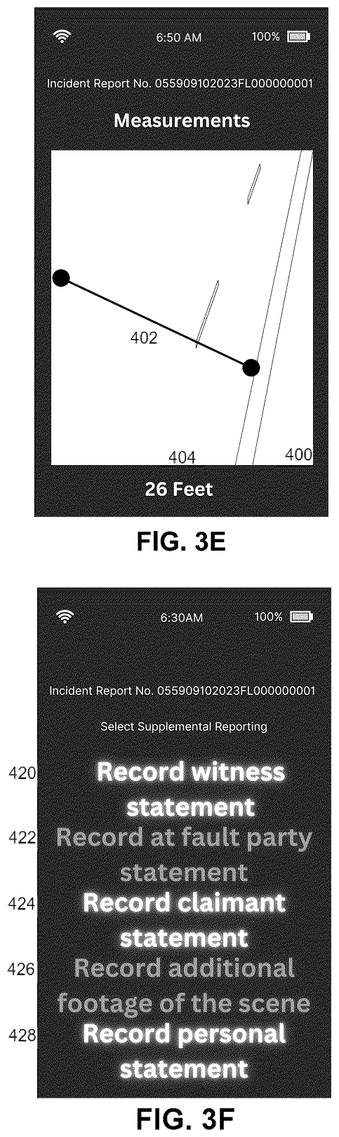

Referring to FIG. 3A, the user interface of the mobile application is depicted as the user begins the process of reporting a car incident. The interface displays a realistic view of the live scene captured by the camera of the mobile device 300. The screen shows the damaged car 302, positioned off the road, providing a clear visual context of the incident.

Audible and visual cues are overlaid on the live scene to guide the user in capturing specific media elements. The visual cues include indicators such as arrows 306 pointing to areas of interest on the damaged car, ensuring that critical aspects of the scene are documented. Additionally, there are icons 308 representing various functionalities and prompts, such as a 360-degree view indicator, to encourage comprehensive scene capture.

The interface includes a recording timer 310 at the bottom left, showing the duration of the recording. The application displays the status of the recording with a “REC” indicator 312 at the top right, confirming that the media capture is active. Audio levels 314 are visualized at the top center, ensuring that the sound is being recorded properly.

On the right side of the screen, multiple icons 316 provide quick access to additional features and information. These include icons for contacting the police, medical services, and towing companies, along with options for accessing user profiles and additional scene details. The high-definition (HD) indicator 318 ensures that the media quality is adequate for detailed analysis.

Referring to FIG. 3B, the user interface of the mobile application is displayed as the user prepares to start live recording of the incident. The screen shows the initial view that the user encounters upon opening the application 320. At the top of the screen, the status bar displays the time 322, battery level 324, and network connection status 326, ensuring the user is aware of the device's readiness for recording and uploading.

The central part of the interface prominently features a large circular button 328 labeled “Click here to record live and auto upload,” guiding the user to initiate the recording process. This clear and straightforward prompt ensures that users can easily start capturing the incident without any confusion.

In the background, the camera viewfinder 330 displays a preview of what the camera is currently capturing, providing the user with a real-time visual of the scene they are about to record. This live preview helps the user position the camera correctly to ensure that all necessary aspects of the incident are within the frame.

Referring to FIG. 3C, the user interface of the mobile application is shown after the live capture has ended. The screen confirms that the media has been successfully captured and uploaded 360, displaying a notification to the user. The incident report number 362 is prominently displayed at the top, uniquely identifying the recorded incident.

The interface prompts the user to choose which parties they would like to associate with this incident 364. This selection process is facilitated by a list of potential relevant parties, including Insurance Carrier 366, Police Department 368, First Responder 370, Attorney 372, Tow 374, and an option for Other 376. This feature allows users to ensure that all pertinent stakeholders are informed and have access to the recorded data.

The screen also displays essential device information, such as the time 378, battery level 380, and network connection status 382, ensuring the user is aware of their device's operational status.

Referring to FIG. 3D, the user interface of the mobile application is shown after the initial incident capture. The screen provides options for additional data collection 380, categorized under “Manual Additions.” The interface displays several selectable options, including capturing damaged property identifying information 382, incident location identifying information 384, first responders identifying information 386, insurance carrier identifying information 388, and capturing a written statement 390. This step allows users to provide comprehensive details about the incident, ensuring that all relevant information is recorded accurately and thoroughly.

Referring to FIG. 3E, the user interface of the mobile application is displayed with an on-screen measuring tool 400. The interface shows an image of the incident scene with visible measurement lines 402, allowing the user to measure distances and dimensions directly within the recorded media. In this example, the measurement tool indicates a distance of 26 feet 404, which might represent the distance between two points of interest, such as skid marks or the distance from the point of impact to the final resting place of the vehicles. This feature enhances the documentation by providing precise spatial information relevant to the incident.

Referring to FIG. 3F, the user interface of the mobile application offers options for additional media collection specific to the evidence needed for the incident. The screen displays selectable options such as recording witness statements 420, at-fault party statements 422, claimant statements 424, additional footage of the scene 426, and personal statements 428. These options ensure that all necessary testimonial and visual evidence is collected. Pieces of evidence on the list that have been uploaded already are indicated by highlighting.

It should be noted that The system is designed to accommodate a wide range of media capture and cataloguing needs beyond incident reporting. One notable feature is its ability to handle non-incident-related media uploads, providing a comprehensive platform for general media documentation and management. Users can utilize the mobile application to capture media of any type, such as property inspections, inventory documentation, or personal archives, and upload it to the repository for secure storage and easy retrieval.

For instance, a real estate agent can use the system to document the condition of a property before listing it for sale. The mobile application can guide the agent through capturing high-quality images and videos of the property, including interior and exterior views, specific features, and any notable conditions. The captured media is uploaded to the server, where it is processed by the AI module to extract relevant data such as room dimensions, visible features, and property conditions. This information is categorized and stored in the repository, allowing potential buyers to search and view detailed visual documentation of the property through unique identifiers like the property address or listing number.

Moreover, the system supports the integration of media from various sources, including dash cameras, body cameras, security cameras, and personal devices. This capability ensures comprehensive coverage and documentation of events and conditions from multiple perspectives. The server's AI processing enhances the utility of the uploaded media by analyzing it for specific attributes, generating thumbnails, and enabling indexed searches based on unique identifiers and metadata.

Additionally, the system includes features for user and third-party interaction, such as the ability to share and grant access to specific media collections. Users can selectively share their uploaded media with designated third parties, such as insurance companies, legal representatives, or service providers, facilitating efficient communication and data exchange.

### CONTROLLER/PROCESSOR COMPONENTS

A user device and/or server as described herein can be any suitable type of computer.

A computer may be a uniprocessor or multiprocessor machine. Accordingly, a computer may include one or more processors and, thus, the aforementioned computer system may also include one or more processors. Examples of processors include sequential state machines, microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), gated logic, programmable control boards (PCBs), and other suitable hardware configured to perform the various functionality described throughout this disclosure.

Additionally, the computer may include one or more memories. Accordingly, the aforementioned computer systems may include one or more memories. A memory may include a memory storage device or an addressable storage medium which may include, by way of example, random access memory (RAM), static random access memory (SRAM), dynamic random access memory (DRAM), electronically erasable programmable read-only memory (EEPROM), programmable read-only memory (PROM), erasable programmable read-only memory (EPROM), hard disks, floppy disks, laser disk players, digital video disks, compact disks, video tapes, audio tapes, magnetic recording tracks, magnetic tunnel junction (MTJ) memory, optical memory storage, quantum mechanical storage, electronic networks, and/or other devices or technologies used to store electronic content such as programs and data. In particular, the one or more memories may store computer executable instructions that, when executed by the one or more processors, cause the one or more processors to implement the procedures and techniques described herein. The one or more processors may be operably associated with the one or more memories so that the computer executable instructions can be provided to the one or more processors for execution. For example, the one or more processors may be operably associated to the one or more memories through one or more buses. Furthermore, the computer may possess or may be operably associated with input devices (e.g., a keyboard, a keypad, controller, a mouse, a microphone, a touch screen, a sensor) and output devices such as (e.g., a computer screen, printer, or a speaker).

The computer may advantageously be equipped with a network communication device such as a network interface card, a modem, or other network connection device suitable for connecting to one or more networks.

A computer may advantageously contain control logic, or program logic, or other substrate configuration representing data and instructions, which cause the computer to operate in a specific and predefined manner as, described herein. In particular, the computer programs, when executed, enable a control processor to perform and/or cause the performance of features of the present disclosure. The control logic may advantageously be implemented as one or more modules. The modules may advantageously be configured to reside on the computer memory and execute on the one or more processors. The modules include, but are not limited to, software or hardware components that perform certain tasks. Thus, a module may include, by way of example, components, such as, software components, processes, functions, subroutines, procedures, attributes, class components, task components, object-oriented software components, segments of program code, drivers, firmware, micro code, circuitry, data, and/or the like.

The control logic conventionally includes the manipulation of digital bits by the processor and the maintenance of these bits within memory storage devices resident in one or more of the memory storage devices. Such memory storage devices may impose a physical organization upon the collection of stored data bits, which are generally stored by specific electrical or magnetic storage cells.

The control logic generally performs a sequence of computer-executed steps. These steps generally require manipulations of physical quantities. Usually, although not necessarily, these quantities take the form of electrical, magnetic, or optical signals capable of being stored, transferred, combined, compared, or otherwise manipulated. It is conventional for those skilled in the art to refer to these signals as bits, values, elements, symbols, characters, text, terms, numbers, files, or the like. It should be kept in mind, however, that these and some other terms should be associated with appropriate physical quantities for computer operations, and that these terms are merely conventional labels applied to physical quantities that exist within and during operation of the computer based on designed relationships between these physical quantities and the symbolic values they represent.

It should be understood that manipulations within the computer are often referred to in terms of adding, comparing, moving, searching, or the like, which are often associated with manual operations performed by a human operator. It is to be understood that no involvement of the human operator may be necessary, or even desirable. The operations described herein are machine operations performed in conjunction with the human operator or user that interacts with the computer or computers.

It should also be understood that the programs, modules, processes, methods, and the like, described herein are but an exemplary implementation and are not related, or limited, to any particular computer, apparatus, or computer language. Rather, various types of general-purpose computing machines or devices may be used with programs constructed in accordance with some of the teachings described herein. In some embodiments, very specific computing machines, with specific functionality, may be required.

### CONCLUSION

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the system and related methods of the invention have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A system for capturing, analyzing, and managing media, comprising:
(a) a mobile device including a camera, a microphone, a touch screen, a processor, and a non-transitory memory having camera-processor-executable instructions stored thereon;
(b) a mobile application operable on the mobile device, the mobile application configured to:
initiate live recording of media via the camera and microphone upon activation by a user;
generate audible and/or visual prompts on the touch screen to guide the user in capturing specific media elements;
generate a unique identifier associated with the recorded media;
prevent alteration or deletion of the recorded media on the mobile device;
upload the recorded media and associated identifier to a server when a network connection is available;
and
(c) a server operably connected to the mobile device, the server configured to:
receive and store the uploaded media and associated identifier;
process the media using artificial intelligence to extract and categorize data;
maintain a repository of stored media, enabling indexed searching by unique identifiers.

2. The system of claim 1, wherein the mobile application is further configured to detect the geolocation of the mobile device and associate the geolocation data with the recorded media.

3. The system of claim 2, wherein the mobile application is further configured to detect the orientation of the mobile device and associate the orientation data with the recorded media.

4. The system of claim 1, wherein the server is further configured to generate thumbnails of the recorded media for display in search results.

5. The system of claim 1, wherein the artificial intelligence on the server is configured to: analyze the media for one or more specific attributes, selected from the group of:
severity of incident, terrain, light exposure, visible logos, license plates, vehicle identification numbers, and spoken words or phrases.

6. The system of claim 1, wherein the mobile application is further configured to generate and embed a digital watermark on the recorded media, identifying the user who captured the media.

7. The system of claim 1, wherein the server is further configured to provide third-party access to the repository, enabling search and retrieval of media by unique identifiers such as vehicle identification numbers or addresses.

8. The system of claim 1, wherein the mobile application is further configured to continue to record media and store it locally on the mobile device when a network connection is unavailable, and automatically upload the media once the network connection is reestablished.

9. The system of claim 1, wherein the mobile application is further configured to receive and upload non-live-captured media from external devices, including dash cameras, body cameras, and security cameras.

10. The system of claim 1, wherein the server is further configured to distribute payments to users based on third-party downloads of the uploaded media.

11. The system of claim 1, wherein the mobile application is further configured to measure distances and dimensions within the recorded media using on-screen tools and prompts.

12. The system of claim 1, wherein the server is further configured to associate additional information provided by the user with the recorded media, selected from the group of: written or audio descriptions, insurance information, police report numbers, and names of involved parties.

13. The system of claim 1, wherein the mobile application is further configured to allow users to capture and record current conditions of property for documentation purposes, including pre-rental or pre-sale inspections.

14. The system of claim 1, wherein the mobile application is further configured to tag and categorize the recorded media based on user input and predefined criteria.

15. The system of claim 1, wherein the server is further configured to integrate with external databases to retrieve and correlate additional information related to the incident, such as weather conditions and traffic reports at the time of the incident.

16. The system of claim 1, wherein the server is further configured to generate detailed reports based on the processed media, including chronological timelines and incident summaries.

17. The system of claim 1, wherein a mobile application integrated within and communicates with a mobile, battery-reliant piece of property, configured such that when the mobile property or mobile device senses an accident, it will automatically start capturing and storing data utilizing the available media-capturing components of the mobile device and application until the user stops it or the battery dies, and extracts analytics from the users' mobile properties CPU and or Event Data Recorder, storing the crash data within the upload to the servers.
